(19) United States
(12) Patent Application Publication
(10) Pub. No.: US 2019/0319442 A1
(43) Pub. Date: Oct. 17, 2019

(54) Power Line Protection Device

(71) Applicant: Eugene Tompkins, Gaylordsville, CT (US)

(72) Inventor: Eugene Tompkins, Gaylordsville, CT (US)

(21) Appl. No.: 16/280,214

(22) Filed: Feb. 20, 2019

Related U.S. Application Data
(60) Provisional application No. 62/657,077, filed on Apr. 13, 2018.

(51) Int. Cl. H02G 7/02

(52) U.S. Cl. CPC H02G 7/02

(57) ABSTRACT

A power line protection device. The power line protection device includes a housing. The housing has a reel inside that is designed to store an electric cord around. The reel is designed to allow expansion and retraction of the electric cord upon the surpassing beyond a pressure threshold upon the electric cord. The housing includes a mounting plate that secures the housing to a support surface. The mounting plate has a rotatable joint.

### CROSS REFERENCE TO RELATED APPLICATIONS

This application claims the benefit of U.S. Provisional Application No. 62/657,077 filed on Apr. 13, 2018. The above identified patent application is herein incorporated by reference in its entirety to provide continuity of disclosure.

### BACKGROUND OF THE INVENTION

The present invention relates to a power line protection device. More specifically, the power line protection device includes a mounting plate with a rotatable joint to minimize tension exerted upon the housing and electric cord extending therefrom.

Overgrowth from vegetation, such as trees and bushes, heavy snowfall, and strong winds may cause power lines to break. When power lines break, a power outage occurs, which will result in a loss of power for any nearby buildings in connection with the broken circuit. In addition to the regular inconvenience associated with power loss, downed power lines can be dangerous to both properties and people located in the area surrounding the downed power lines.

Typically, electric companies will dispatch crews to return the downed power lines to their functional positions. However, this work, in addition to being dangerous, can be time-consuming. In particular, when events such as hurricanes or snow storms cause multiple power outages, these crews may be overbooked, causing significant delays for power customers. Therefore, a safe and effective solution is desired that will minimize the damages and costs associated with downed power lines.

### SUMMARY OF THE INVENTION

In view of the foregoing disadvantages inherent in the known types of power line protection devices now present in the known art, the present invention provides a power line protection device wherein the same can be utilized for providing convenience for the user when minimizing the damages and costs associated with power outages resulting from downed power lines.

The present system comprises a housing with a reel integrated therein. An electric cord is stored upon the wheel in a plurality of overlapping coils. The electric cord has a first end disposed oppositely of a second end. The reel is configured to enable expansion and retraction of the electric cord. A mounting plate is disposed on an external surface of the housing. The mounting plate comprises a rotatable joint, such that the housing is movably affixed to the support structure.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the power line protection device.

FIG. 2 shows a perspective view of an embodiment of the power line protection device in use.

### DETAILED DESCRIPTION OF THE INVENTION

Reference is made herein to the attached drawings. Like reference numerals are used throughout the drawings to depict like or similar elements of the power line protection device. The figures are intended for representative purposes only and should not be considered to be limiting in any respect.

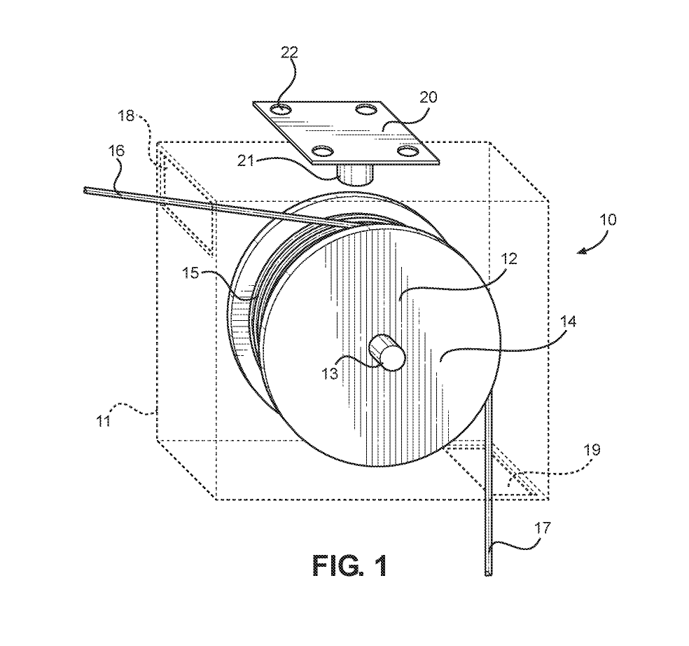

Referring now to FIG. 1, there is shown a perspective view of an embodiment of the power line protection device. A power line protection device 10 comprises a housing 11. In the illustrated embodiment, the housing 11 is a rectangular box-shaped housing 11. In an alternate embodiment, the housing 11 is shaped symmetrical to a reel 12 disposed therein. The housing 11 is waterproof, such that water will be prevented from entering the interior of the housing 11 and the components therein will be protected from water damage.

The housing 11 contains a reel 12 disposed therein. The reel 12 comprises a pin 13 with a track 14 rotatably disposed thereon. The pin 13 extends between a first sidewall of the housing 11 to an opposing sidewall of the housing 11. The pin 13 is made of an entirely smooth material, such as to reduce friction as the track 14 rotates upon the pin 13. In the illustrated embodiment, the track 14 comprises a pair of planar disc members oriented parallel to each other. A channel is defined between the planar disc members. The channel is dimensioned to receive a cord therein. In one embodiment, the housing 11 and the reel 12 are made of a non-conductive molded plastic.

The reel 12 is configured to enable expansion and retraction of an electric cord 15. For example, the cord can be deployed when the reel rotates in a first direction about the pin, while the cord is stored on the track 14 when the wheel rotates in a second direction. The electric cord 15 is stored upon the reel 12 in a plurality of overlapping coils. The electric cord 15 has a first end 16 oppositely disposed a second end 17. In one embodiment, the electric cord 15 comprises a non-conductive plastic material disposed around a conductive wire. The electric cord 15 is of any suitable material or configuration for transferring an electric current from a utility line to a home or a business.

In one embodiment, the reel 12 comprises a spring rewind. The spring rewind is configured to allow locking expansion of the electric cord 15 when pulled until a pulling threshold is passed and the electric cord 15 is retracted by the spring rewind. In another embodiment, the spring rewind is operably connected to a switch, wherein actuation of the switch causes retraction of the electric cord 15. In yet another embodiment, the reel 12 is operably connected to a motor, such that the motor can expand and retract the electric cord 15.

In the illustrated embodiment, the first end 16 of the electric cord 15 extends through a first opening 18 disposed in an upper portion of a sidewall of the housing 11. The first opening 18 is dimensioned to provide sufficient space for the electric cord to pass through the first opening 18 as the reel 12 is rotated. In the illustrated embodiment, the first end 16 of the electric cord 15 comprises an interface configured to receive at least one power line or utility line.

Further in the illustrated embodiment, the second end 17 of the electric cord 15 extends through a second opening 19 in a base of the housing 11. The second end 17 of the electric cord 15 is configured to attach to the electrical input of a building, such that a circuit is completed between the power line and the building.

The housing 11 comprises a mounting plate 20 on an external surface thereof. The mounting plate 20 comprises a rotatable joint 21, such that the housing 11 is rotatable around the rotatable joint 21. In the illustrated embodiment, the mounting plate 20 comprises a plurality of apertures 22. The plurality of apertures 22 are configured to receive a fastener therethrough. The fastener passes through each aperture of the plurality of apertures 22 such that the housing 11 is secured to a support structure by the fastener.

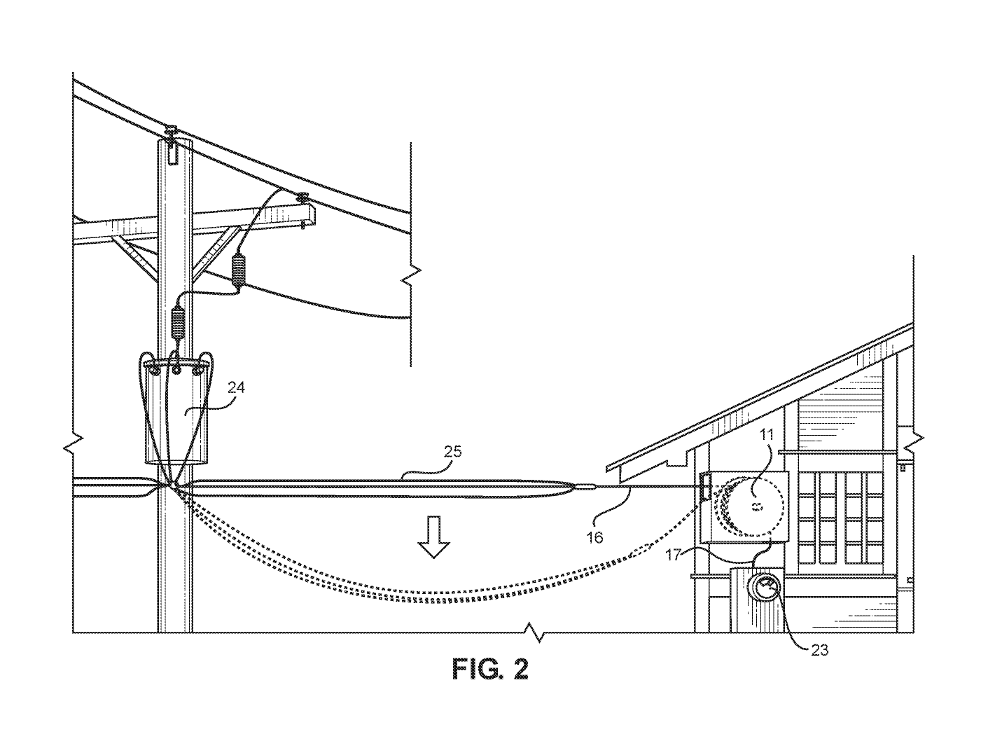

Referring now to FIG. 2, there is shown a perspective view of an embodiment of the power line protection device in use. In use, the housing 11 is secured to a support structure. In the illustrated embodiment, the housing is secured to a side wall of a building. The second end 17 of the electric cord extends from the housing 11 to an electric input 23 of the building. The first end 16 of the electric cord extends from the housing 11 to at least one utility line 25. The utility lines 25 extend from the first end 16 of the electric cord to the power line housing 24.

As illustrated, when an excessive amount of weight is applied to the utility lines 25, the first end 16 of the electric cord will extend from the housing 11 such that slack is provided to the utility lines 25. By supplying slack to the utility lines 25 in response to weight applied thereto, the risk of breakage to the utility lines 25 is reduced in direct response to the application of weight upon the utility lines 25.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A power line protection device comprising:
a housing comprising a reel therein;
an electric cord stored upon the reel in a plurality of overlapping coils having a first end opposite a second end;
the reel configured to enable expansion and retraction of the electric cord;
the housing having a mounting plate on an external surface thereof;
the mounting plate comprising a rotatable joint.

2) The power line protection device of claim 1, wherein reel comprises a spring rewind.

3) The power line protection device of claim 2, wherein the spring rewind is operably connected to a switch.

4) The power line protection device of claim 2, wherein the spring rewind is configured to act as a pull and release retraction mechanism.

5) The power line protection device of claim 2, wherein the spring rewind is operably connected to a motor.

6) The power line protection device of claim 1, wherein the electric cord comprises a non-conductive plastic disposed around a conductive wire.

7) The power line protection device of claim 1, wherein the housing, the mounting plate, and the reel are made of a non-conductive molded plastic.

8) The power line protection device of claim 1, wherein the first end of the electric cord extends through a first opening in the housing and the second end of the electric cord extends through a second opening in the housing.

9) The power line protection device of claim 8, wherein the first opening in the housing is through an upper end of a sidewall of the housing and the second opening in the housing is through a base of the housing.
